(19) United States
(12) Patent Application Publication
(10) Pub. No.: US 2020/0175613 A1
(43) Pub. Date: Jun. 4, 2020

(54) Performance Data Management Device

(71) Applicant: Hitachi, Ltd., Tokyo (JP)

(72) Inventors: Takayoshi UENO, Tokyo (JP); Yoshinori MOCHIZUKI, Tokyo (JP); Masatoshi IWAIDA, Tokyo (JP)

(21) Appl. No.: 16/681,987

(22) Filed: Nov. 13, 2019

(30) Foreign Application Priority Data
Nov. 29, 2018 (JP) 2018-223618

(51) Int. Cl. G06Q 50/04; G06F 16/22; G06F 16/28; G06Q 10/06

(52) U.S. Cl. CPC G06Q 50/04; G06Q 10/06395; G06F 16/285; G06F 16/2282

(57) ABSTRACT

One aspect of the invention includes: a performance data collection processing unit that classifies performance data for each type of a resource based on business context indicating a relationship between business and the resource for the performance data, which is generated by a manufacturing site system and includes information on at least the business and the resource; and a business data generation processing unit that associates the business with the performance data classified for each resource type based on the business context and generates business data.

### BACKGROUND OF THE INVENTION

### 1. Field of the Invention

The present invention relates to a performance data management device that manages performance data for use by a business application.

### 2. Description of the Related Art

A business application is a program developed to process business on a computer, and is used for business efficiency and business improvement. Some business applications are operated as so-called computerized information systems applied from business in which computerization is easy to spread

In these information systems, the systems are further connected to each other, and data handled therein drastically increases and is referred to as so-called big data. Nowadays, a data analysis technique for the big data has improved.

Meanwhile, an IoT technique that connects a man and things has progressed, a business application that is excellent in data analysis technique has been applied not only in a factory automation (FA) manufacturing site control system (manufacturing site system) but also in an information system in connection with a man (or information obtained through the man), devices, or the like.

For example, JP 2012-159998 A discloses a technique of defining business contents so as to realize business applications corresponding to various types of business without modifying a program.

### SUMMARY OF THE INVENTION

There has ever been a business application that uses performance data of a manufacturing site, data indicating performance which is a result of movement and operation of a so-called control system or the like. The business application itself that handles the performance data can be prepared by some methods such as in-house development, commissioned development, and purchase of a software package. However, the performance data, which is used by the business application and conforms to the specifications of the business application, needs to be obtained and prepared by devising some methods. In particular, when conducting the in-house development or commissioned development, a mechanism for acquiring the performance data at a manufacturing site and a mechanism for managing are developed together in many cases.

Furthermore, when the performance data is used and utilized to develop a new business application, there is a case where it is necessary to develop an additional acquisition method because the required performance data has not been acquired, for example. For example, it is necessary to newly study a transmission medium, a communication protocol, a transmission data structure (information content), and the like in the development of the acquisition method. Further, there are cases in which an existing business application needs to be modified in order to use acquired data. In these cases, it is necessary to broaden knowledge beyond the scope of original development, and a burden on a person in charge of developing business applications tends to increase.

The person in charge of developing the business application and a person in charge of operating and managing the information system are rarely familiar with detailed specifications of the manufacturing site, particularly the control system. This is because a technique required for each of the information system (business application) and the control system is more specialized. Further, the control system often exhibits various aspects since a management organization selects a scale and a production scheme of production equipment suitable for the company at the manufacturing site. Even in JP 2012-159998 A, it is assumed that data used by the business application is already prepared in an external database. Therefore, the technique described in JP 2012-159998 A does not reduce work for organizing and managing performance data in cooperation between the person in charge of the control system and the person in charge of the business application.

The invention has been made in view of the above situation, and an object thereof is to enable a reference source of performance data to easily refer only to require performance data among a large number of pieces of performance data generated by a control system at a manufacturing site.

In order to solve the above problem, a performance data management device according to one aspect of the invention includes: a performance data collection processing unit that classifies performance data for each type of a resource based on business context indicating a relationship between business and the resource when the performance data generated by a manufacturing site system includes information indicating the type of the resource used to perform the business, time at which performance of the resource has occurred, information indicating a material to be manufactured by performing the business, information indicating the business, information indicating the resource, and information indicating the performance of the resource; a performance data storage unit that stores the performance data classified for each type of the resource; a business data generation processing unit that associates the business with the performance data classified for each type of the resource based on the business context and generates business data; and a business data storage unit that stores the business data for each type of the resource.

Further, a performance data management device according to another aspect of the invention includes: a performance data collection processing unit that classifies performance data for each type of a resource based on business context indicating a relationship between business and the resource when the performance data generated by a manufacturing site system includes information indicating the type of the resource used to perform the business, time at which performance of the resource has occurred, information indicating a material to be manufactured by performing the business, information indicating the resource, and information indicating the performance of the resource; a performance data storage unit that stores the performance data classified for each type of the resource; a business data generation processing unit that associates the business with the performance data classified for each type of the resource based on the business context and generates business data; and a business data storage unit that stores the business data for each type of the resource.

According to the performance data management device of at least one or another aspect of the invention, a large number of pieces of performance data and business generated by the manufacturing site system are managed for each resource type. As a result, a reference source of the performance data can refer only to required performance data easily from among a large number of pieces of performance data.

Other objects, configurations, and effects which have not been described above become apparent from embodiments to be described hereinafter.

### BRIEF DESCRIPTION OF THE DRAWINGS

FIG. 1 is a diagram illustrating an example of a manufacturing site system;

FIG. 2 is a block diagram illustrating an overall configuration example of a business management system in which a business application according to one embodiment of the invention uses performance data of the manufacturing site system;

FIG. 3 is a block diagram illustrating a hardware configuration example of a computer included in each device constituting the manufacturing site system and the business management system;

FIG. 4 is a block diagram illustrating a configuration example of a business context definition execution unit according to the embodiment of the invention;

FIG. 5 is a diagram illustrating a configuration example of a business context storage unit according to the embodiment of the invention;

FIG. 6 is a diagram illustrating a configuration example of each master table stored in the business context storage unit according to the embodiment of the invention;

FIG. 7 is a view illustrating a configuration example of a business context definition screen according to the embodiment of the invention;

FIG. 8 is a diagram illustrating an example of types of data included in performance data output from the manufacturing site system according to the embodiment of the invention;

FIG. 9 is a diagram illustrating an example of contents of performance data for each type according to the embodiment of the invention;

FIG. 10 is a diagram illustrating a configuration example of a performance data storage unit according to the embodiment of the invention;

FIG. 11 is a diagram illustrating a configuration example of each performance data table stored in the performance data storage unit according to the embodiment of the invention;

FIG. 12 is a diagram illustrating a configuration example of a business data storage unit according to the embodiment of the invention;

FIG. 13 is a diagram illustrating a configuration example of each business data table stored in the business data storage unit according to the embodiment of the invention;

FIG. 14 is a flowchart illustrating an example of a processing procedure of a performance data collection processing unit according to the embodiment of the invention;

FIG. 15 is a flowchart illustrating an example of a processing procedure of a business data generation processing unit according to the embodiment of the invention;

FIG. 16 is a flowchart illustrating an example of a processing procedure of a business context automatic registration processing unit according to the embodiment of the invention;

FIG. 17 is a diagram illustrating a configuration example of a first business data storage unit according to the embodiment of the invention;

FIG. 18 is a diagram illustrating a configuration example of a process management data table according to the embodiment of the invention; and

FIG. 19 is a flowchart illustrating an example of a processing procedure of first business ETL according to the embodiment of the invention.

### DESCRIPTION OF THE PREFERRED EMBODIMENTS

It is conceivable to improve business in order to achieve a key performance indicator (KPI) targeted by a management organization for a purpose that a business application handles performance data. In general, four elements of production can be classified into so-called 4M of a man, machine, a material, and a method. Then, business is analyzed from the viewpoint of the four elements of production.

In general, business is repeatedly performed, and accordingly, a lot of performance data is generated by a control system. Thus, as the number of times of performing business increases, it becomes very troublesome for a person in charge of the control system to identify the business that has been performed and performance data that has been generated along with the performed business and to additionally define an association between business and performance data in context information each time business is performed. Therefore, the inventors have invented a method for managing performance data to reduce a burden on the person in charge of a business application and a person in charge of the control system.

### 1. First Embodiment

Hereinafter, examples of modes for carrying out the invention (hereinafter referred to as “embodiments”) will be described with reference to the attached drawings. In the present specification and attached drawings, constituent elements having substantially the same function or configuration will be denoted by the same reference sign, and the redundant description thereof will be omitted.

In a performance data management system according to one embodiment of the invention, a series of types of work on a manufacturing site is defined as business, resources that generate performance data as the business is performed are classified into 4M of production, and the resources and the performance data generated by the resources are associated with the business to perform management for each type of 4M.

As the embodiment of the invention, a description will be regarding a case in which the invention is applied to a business management system in which a business application uses performance data of a manufacturing site system.

### [Example of Manufacturing Site System]

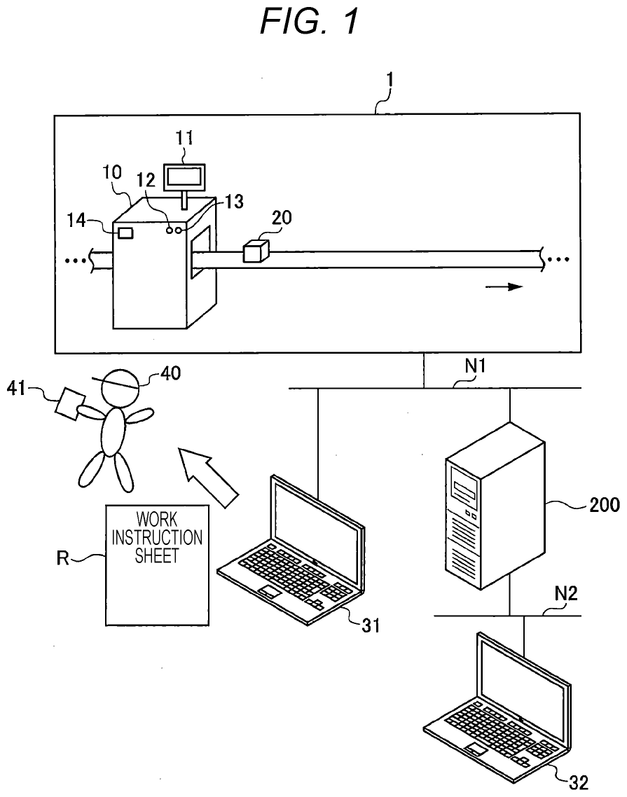

FIG. 1 is a diagram illustrating an example of a manufacturing site system. A manufacturing site system 1 (an example of a control system) illustrated in FIG. 1 is constituted by processing machine 10 that produces a processed product 20 by performing preset processing on a workpiece and a plurality of devices such as assembling machine and inspection machine (not illustrated). The manufacturing site system 1 is connected with a controller (not illustrated) which controls the manufacturing site system 1 based on various state quantities and production targets acquired from the manufacturing site system 1. The processing machine 10 is provided with an operation panel 11, a processing start button 12, a processing end button 13, and a reader/writer device 14 in a casing that protects the processing machine.

The manufacturing site system 1 is connected to a terminal device 31 and a performance data management device 200 via a field network N1. The performance data management device 200 is connected to a terminal device 32 via a control network N2. The field network N1 and the control network N2 are wired or wireless local area networks (LANs). Such a network configuration is an example, and for example, a controller may be connected between the manufacturing site system 1 and the field network N1.

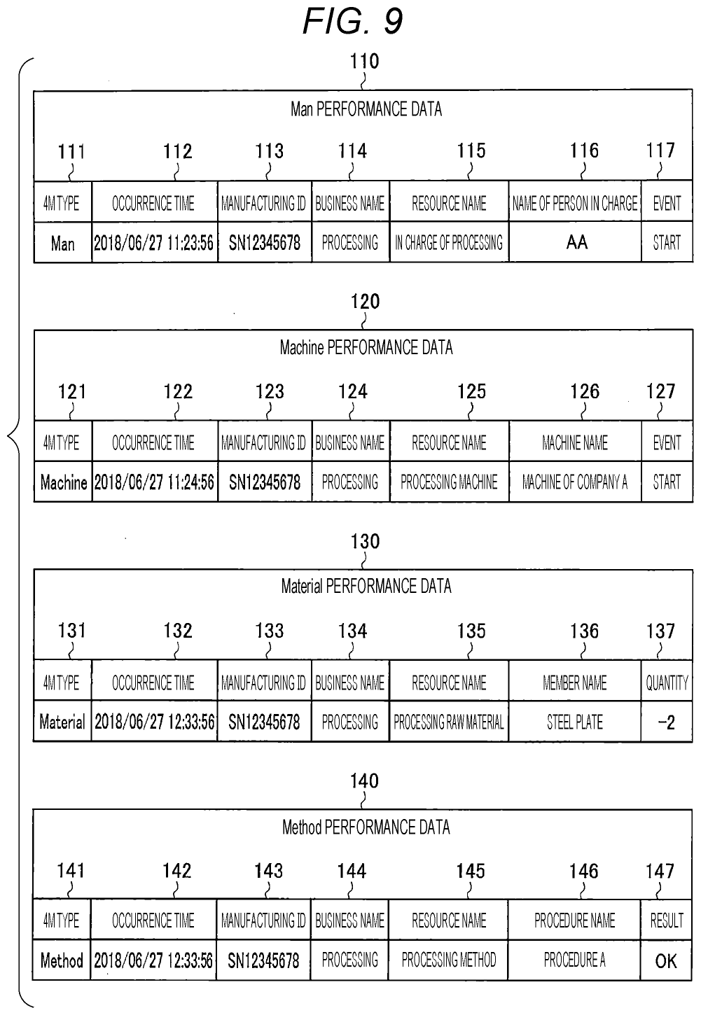

A worker 40 views a work instruction sheet R displayed on the terminal device 31 or a work content described in a printed material of the work instruction sheet R to confirm that processing work has been instructed and operates the processing machine 10. For example, before operating the processing machine 10, the worker 40 places an employee card 41 made of an IC card on the reader/writer device 14 of the processing machine 10 and inputs worker information recorded on the IC chip of the employee card 41 to the processing machine 10. As a result, the worker information (a resource name and a name of a person in charge in FIG. 9 which will be described later) of the worker 40 operating the processing machine 10 is recorded in the processing machine 10, that is, the manufacturing site system 1.

Thereafter, when the worker 40 presses the processing start button 12 and the processing end button 13 based on the work instruction sheet, the processing machine 10 executes processing start and processing end. This processing machine 10 (manufacturing site system 1) adds information indicating a type of a resource to information indicating operation performance, and outputs the addition result as performance data. The performance data is taken into the performance data management device 200 to be described later and classified for each type of resources.

Similarly, the worker 40 in charge of work performs assembling work, inspection work, or other work based on the work instruction sheet R such that each performance data is taken into the performance data management device 200 and classified for each type of resources. In the embodiment, a series of types of work on the manufacturing site is referred to as “business”.

When the worker 40 operates the operation panel 11 or operates the terminal device 31, the worker information of the worker 40 (and information on the processing start by the worker 40) may be registered in the performance data management device 200. Further, when the worker 40 may input processing start and processing end commands via the operation panel 11 such that the processing machine 10 executes the processing start and processing end.

For example, the worker 40 may operate the operation panel 11 or the terminal device 31 to input worker information such that an operation procedure that allows a processing start command to the processing machine 10 is set. In this case, it may be configured such that the registration of the worker information (processing start information input by the worker 40) and the processing start of the processing machine 10 are registered into the performance data management device 200 at the same time.

Further, the processing machine 10 may include a code reader, and the worker 40 may operate the code reader to read information of a code (a bar code, a two-dimensional code, or the like) for each work printed (displayed) on the work instruction sheet R such that the processing start or processing end is instructed to the processing machine 10.

### [Overall Configuration of Business Management System]

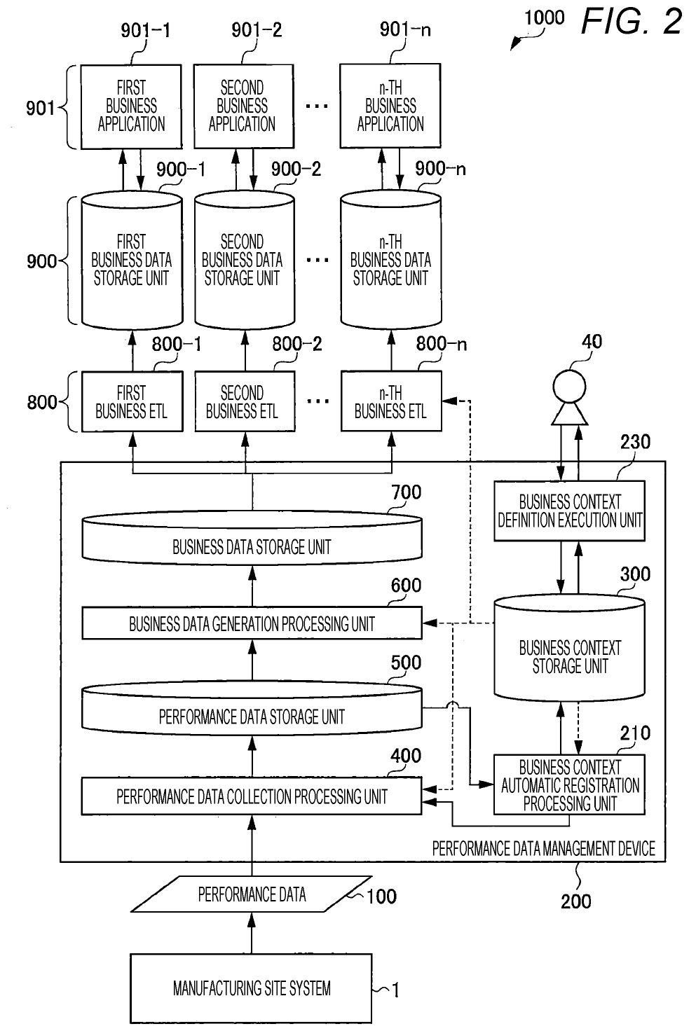

FIG. 2 is a block diagram illustrating an overall configuration example of a business management system 1000 in which a business application according to the embodiment uses performance data of the manufacturing site system 1. A broken-line arrow in FIG. 2 indicates that business context stored in the business context storage unit 300 is referred to.

The business management system 1000 includes: the performance data management device 200 that acquires and manages performance data 100 of the manufacturing site system 1; business extract/transform/load (ETL) 800; a business data storage unit 900; and a business application 901.

The manufacturing site system 1 generates the performance data 100 including information indicating performance of the manufacturing site system 1 and transmits the performance data 100 to the performance data management device 200. The performance of the manufacturing site system 1 includes a produced material, a consumed material, and the like as a result of the movement and operation of the manufacturing site system 1.

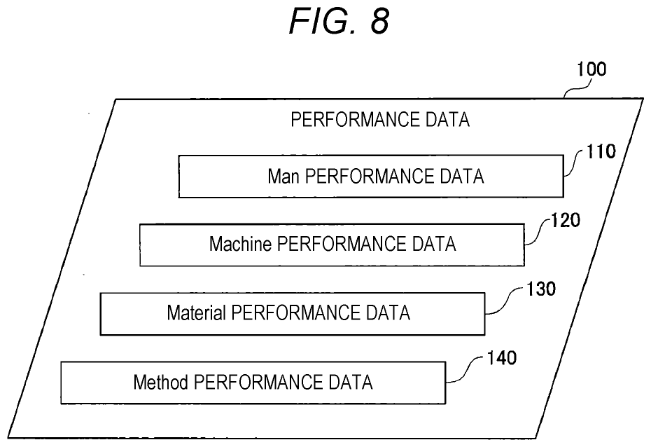

The performance data 100 includes information used in the business application. For example, the performance data 100 includes information indicating a type of a resource to be used to perform business (generate the performance data 100), time when resource performance has occurred, information indicating a material (product) to be manufactured by performing the business, information indicating business, information indicating the resource, information indicating details of the resource, and information indicating the resource performance. In the embodiment, the resource type indicates, for example, four elements (4M) of production. A more specific example of the performance data will be described later with reference to FIGS. 8 and 9 to be described later.

### (Performance Data Management Device)

The performance data management device 200 performs processing of collecting the performance data 100 generated by the manufacturing site system 1, classifying the performance data 100 for each resource type based on business context to be described later, creating business data from the performance data 100, and providing the business data to the business application 901.

The performance data management device 200 includes a performance data collection processing unit 400, a performance data storage unit 500, a business data generation processing unit 600, a business data storage unit 700, a business context definition execution unit 230, a business context automatic registration processing unit 210, and a business context storage unit 300.

When each information described above is included in the performance data 100, the performance data collection processing unit 400 performs processing of classifying the performance data 100 for each resource type based on the business context indicating a relationship between business and a resource stored in the business context storage unit 300.

The performance data storage unit 500 is a non-volatile or volatile storage unit that stores the performance data classified for each resource type by the performance data collection processing unit 400.

The business data generation processing unit 600 performs processing of associating (aggregating) business with performance data classified for each resource type based on the business context stored in the business context storage unit 300, thereby generating business data.

The business data storage unit 700 is a non-volatile or volatile storage unit that stores the business data for each resource type generated by the business data generation processing unit 600.

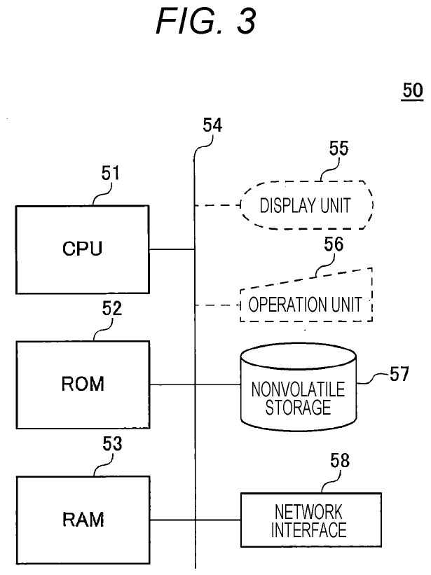

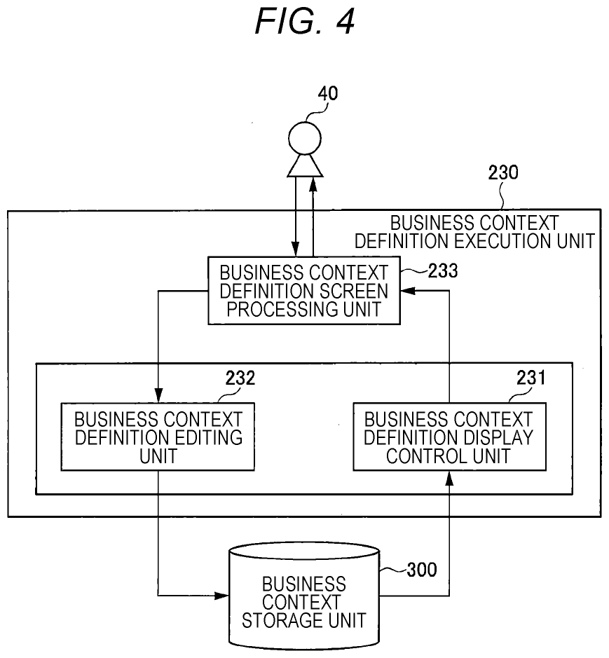

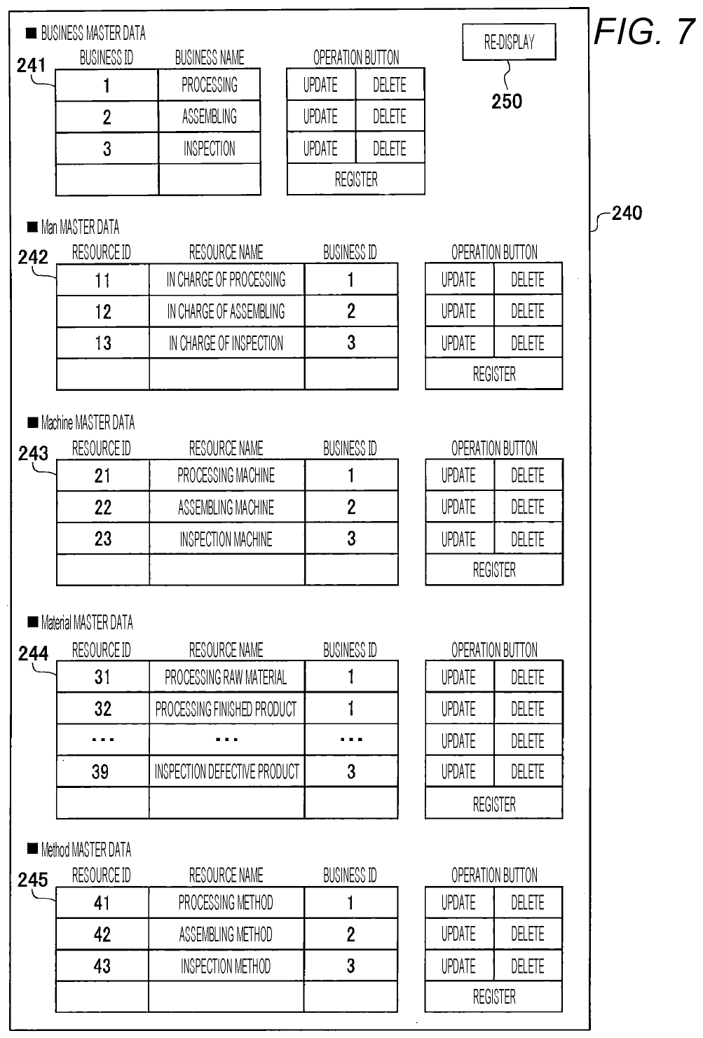

The business context definition execution unit 230 is a processor configured to define a relationship between business and a resource associated with the business as business context based on an instruction input by the worker 40 via the operation unit 56 (see FIG. 3). The business context definition execution unit 230 will be described in detail with reference to FIGS. 4 and 7 to be described later.

When it is difficult to classify the performance data 100 by the business context in the performance data collection processing unit 400, the business context automatic registration processing unit 210 generates new business context based on the information added to the performance data 100 and automatically registers the new business context in the business context storage unit 300. When there is no business context corresponding to performance data to be processed in the business context storage unit 300, it is difficult to classify the performance data for each resource type.

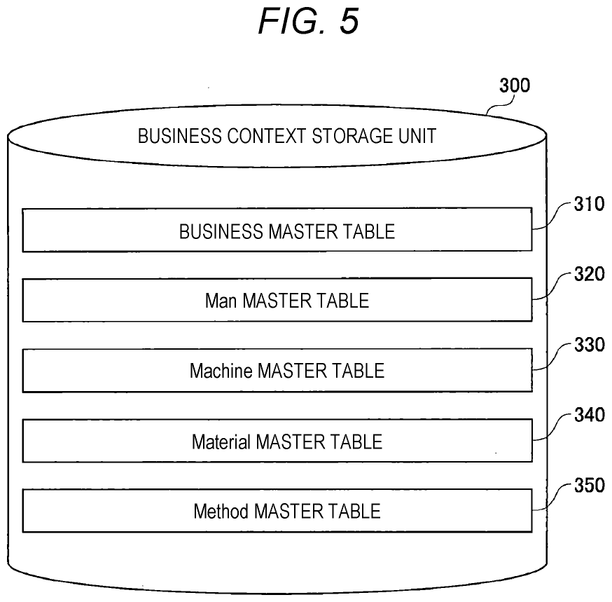

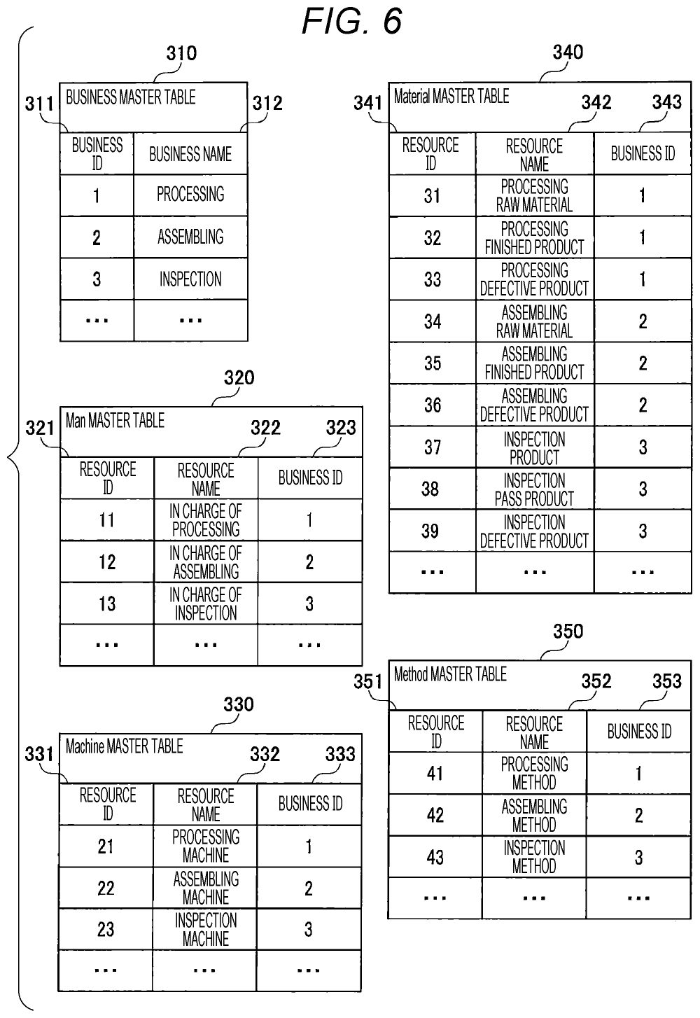

The business context storage unit 300 is a non-volatile or volatile storage unit that stores the business context generated by the business context definition execution unit 230 and the business context automatic registration processing unit 210. The business context will be described in detail with reference to FIGS. 5 and 6 to be described later.

The business ETL 800 is a business data conversion processing unit that performs processing of extracting performance data corresponding to a designated manufacturing ID or business ID from the performance data, which has been classified for each resource type and stored as the business data in the business data storage unit 700, and converting the performance data according to a purpose (the business application 901). The business ETL 800 stores the performance data that has been subjected to the conversion processing in the business data storage unit 900. In FIG. 2, the business ETL 800 includes a first business ETL 800-1, a second business ETL 800-2, . . . , and an n-th business ETL 800-n.

The business data storage unit 900 is a non-volatile or volatile storage unit that stores the business data which has extracted from the business data storage unit 700 and converted according to the purpose by the business ETL 800. The business data storage unit 900 includes a first business data storage unit 900-1, a second business data storage unit 900-2, . . . , and an n-th business data storage unit 900-n.

The business application 901 is an application used for business efficiency and business improvement, and uses the business data stored in the business data storage unit 900.

In FIG. 2, the business application 901 include a first business application 901-1, a second business application 901-2, . . . , and an n-th business application 901-n. The first business data storage unit 900-1 and the first business ETL 800-1 are provided to be associated with the first business application 901-1. The second business data storage unit 900-2 and the second business ETL 800-2 are provided to be associated with the second business application 901-2. The n-th business data storage unit 900-n and the n-th business ETL 800-n are provided to be associated with to the n-th business application 901-n.

### <Hardware Configuration of Each Device>

FIG. 3 is a block diagram illustrating a hardware configuration example of a computer included in each device constituting the manufacturing site system 1 and the business management system 1000. Each unit in a device is selected according to a function and a purpose of use of each device. Here, a hardware configuration example of the above-described performance data management device 200 will be described.

A computer 50 of the performance data management device 200 includes a central processing unit (CPU) 51, a read only memory (ROM) 52, a random access memory (RAM) 53, a non-volatile storage 57, and a communication interface 58. The respective units in the performance data management device 200 are connected via a system bus 54 so as to be capable of mutually transmitting and receiving data.

The CPU 51, the ROM 52, and the RAM 53 constitute a control unit. This control unit controls an operation of the entire performance data management device 200 or each unit thereof. The CPU 51 reads a program code of software that implements each function according to the embodiment from the ROM 52 and executes the read program code, and performs control of each unit and various calculations. Instead of the CPU 51, another arithmetic processing unit such as a micro processing unit (MPU) may be used.

The ROM 52 is used as an example of a non-volatile memory (recording medium), and the ROM 52 stores a program, data, and the like necessary for the CPU 51 to operate. The RAM 53 is used as an example of a volatile memory, and the RAM 53 temporarily stores a variable, a parameter, and the like generated during arithmetic processing by the CPU 51.

The non-volatile storage 57 is an example of a recording medium, and can store a program such as an operating system (OS), a parameter to be used when executing the program, data obtained by executing the program, and the like. For example, the performance data storage unit 500, the business data storage unit 700, and the business context storage unit 300 in FIG. 2 are configured using the non-volatile storage 57.

The non-volatile storage 57 may store a program to be executed by the CPU 51. As the non-volatile storage 57, a semiconductor memory, a hard disk, a solid state drive (SSD), a recording medium using magnetism or light, or the like is used. The program may be provided via a wired or wireless transmission medium such as a local area network (LAN), the Internet, and digital satellite broadcasting.

As the communication interface 58, for example, a network interface card (NIC) or a modem is used, and the communication interface 58 is configured such that various types of data can be transmitted to and received from an external device via a network such as LAN or a dedicated line to which a terminal is connected.

The computer 50 may be provided with a display unit 55 such as a liquid crystal display and the operation unit 56 such as a mouse and a keyboard. The display unit 55 displays a GUI screen and a result of processing performed by the CPU 51, and the operation unit 56 generates an input signal corresponding to user's operation and supplies the input signal to the CPU 51. For example, the worker 40, a system administrator, or the like can confirm a business context definition screen 240 displayed on the display unit 55 and perform necessary editing through the operation unit 56.

The terminal devices 31 and 32 illustrated in FIG. 1 can have the same hardware configuration as the above-described performance data management device 200. Further, a device on which at least the business ETL 800 and/or the business application 901 are mounted can also have the hardware configuration illustrated in FIG. 3.

### [Business Context Definition Execution Unit]

Next, the business context definition execution unit 230 will be described in detail.

FIG. 4 is a block diagram illustrating a configuration example of the business context definition execution unit 230. FIG. 4 will be described assuming that the performance data management device 200 includes the display unit 55 and the operation unit 56.

The business context definition execution unit 230 includes a business context definition display control unit 231, a business context definition editing unit 232, and a business context definition screen processing unit 233. The business context definition display control unit 231 and the business context definition editing unit 232 correspond to a server (application software). The business context definition screen processing unit 233 corresponds to a browser (application software).

The business context definition display control unit 231 reads business context from the business context storage unit 300 and outputs a file of the business context together with a file of the business context definition screen 240 (see FIG. 7) to the business context definition screen processing unit 233.

The business context definition screen processing unit 233 constructs the business context definition screen 240 based on the respective files of the business context and the business context definition screen 240 input from the business context definition display control unit 231, and displays the business context definition screen 240 on the display unit 55. Further, the business context definition screen processing unit 233 outputs an editing instruction for the business context made by the worker 40 or the like having viewed the business context definition screen 240 through the operation unit 56 to the business context definition editing unit 232.

The business context definition editing unit 232 edits the business context based on the editing instruction input from the business context definition screen processing unit 233 and stores the edited business context in the business context storage unit 300.

### [Business Context]

FIG. 5 is a diagram illustrating a configuration example of the business context storage unit 300.

The business context storage unit 300 stores a business master table 310, a man master table 320, a machine master table 330, a material master table 340, and a method master table 350. The business context is constituted by these master tables.

FIG. 6 is a diagram illustrating a configuration example of each master table stored in the business context storage unit 300. Basically, each master table stores resource identification information (a resource ID) for identifying a resource associated with business and business identification information (a business ID) indicating which business the resource belongs to.

### (Business Master Table)

The business master table 310 has a business ID field 311 and a business name field 312, and a correspondence between a business ID and a business name is registered therein. The business ID field 311 indicates business identification information. The business name field 312 indicates a name of business in which a resource is used. In the example of FIG. 6, a business name “processing” is associated with a business ID “1”, a business name “assembling” is associated with a business ID “2”, and a business name “inspection” is associated with a business ID “3”.

### (Man Master Table)

The man master table 320 has a resource ID field 321, a resource name field 322, and a business ID field 323, and a correspondence among a resource ID, a resource name, and a business ID is registered therein. The resource ID field 321 indicates resource identification information of a resource classified as “man”. The resource name field 322 indicates a resource name. The business ID field 323 corresponds to the business ID field 311 and indicates the business identification information. In the example of FIG. 6, a resource name “person in charge of processing” and the business ID “1” are associated with a resource ID “11”. A resource name “person in charge of assembling” and the business ID “2” are associated with a resource ID “12”. A resource name “person in charge of inspection” and the business ID “3” are associated with a resource ID “13”.

### (Machine Master Table)

Similarly, the machine master table 330 also has a resource ID field 331, a resource name field 332, and a business ID field 333, and a correspondence among a resource ID, a resource name, and a business ID is registered therein. The resource ID field 331 indicates resource identification information of a resource classified as “machine”. The resource name field 332 indicates a resource name. The business ID field 333 corresponds to the business ID field 311. In the example of FIG. 6, a resource name “processing machine” and the business ID “1” are associated with a resource ID “21”. A resource name “assembling machine” and the business ID “2” are associated with a resource ID “22”. A resource name “inspection machine” and the business ID “3” are associated with a resource ID “23”.

### (Material Master Table)

Similarly, the material master table 340 also has a resource ID field 341, a resource name field 342, and a business ID field 343. The resource ID field 341 indicates resource identification information of a resource classified as “material”. The resource name field 342 indicates a resource name. The business ID field 343 corresponds to the business ID field 311. In FIG. 6, for example, a resource name “processing raw material” and the business ID “1” are associated with a resource ID “31”. A resource name “processing finished product” and the business ID “1” are associated with a resource ID “32”. A resource name “processing defective product” and the business ID “1” are associated with a resource ID “33”.

### (Method Master Table)

Similarly, the method master table 350 also has a resource ID field 351, a resource name field 352, and a business ID field 353. The resource ID field 351 indicates resource identification information of a resource classified as “method”. The resource name field 352 indicates a resource name. The business ID field 353 corresponds to the business ID field 311. In the example of FIG. 6, a resource name “processing method” and the business ID “1” are associated with a resource ID “41”. A resource name “assembling method” and the business ID “2” are associated with a resource ID “42”. A resource name “inspection method” and the business ID “3” are associated with a resource ID “43”.

### [Business Context Definition Screen]

FIG. 7 is a view illustrating a configuration example of the business context definition screen 240.

The business context definition screen 240 includes each display area for business master data 241, man master data 242, machine master data 243, material master data 244, and method master data 245. Contents of each master table illustrated in FIG. 6 are displayed in the display area of each master data. Icons of operation buttons are displayed next to the display area of each master data. The operation buttons include an update button, a delete button, and a registration button. The business context definition screen 240 is provided with a re-display button 250.

When the business context definition screen processing unit 233 detects that the update button or the delete button is pressed by the system administrator or a person in charge of work via the operation unit 56 or the like, the business context definition editing unit 232 performs update processing or deletion processing. As a result, the worker 40 or the like can update (change) and delete a content for each record of each master table. Further, the registration button is provided for each master data, and a new record can be additionally registered.

In addition, when the re-display button 250 is pressed, the business context definition screen processing unit 233 notifies the business context definition display control unit 231 of pressing of the re-display button 250. After updating information of each master table, the business context definition display control unit 231 re-creates image data of the business context definition screen 240 and transmits the image data to the business context definition screen processing unit 233. As a result, the business context definition screen processing unit 233 can re-draw the business context definition screen 240 reflecting latest information and display the re-drawn business context definition screen 240 on the display unit 55 or the like.

[Performance Data Output from Manufacturing Site System]

Next, the performance data 100 output from the manufacturing site system 1 will be described with reference to FIGS. 8 and 9.

FIG. 8 is a diagram illustrating an example of types of data included in the performance data 100. In the embodiment, types of the performance data 100 include man performance data 110 that uses a man as a resource, machine performance data 120 that uses machine as a resource, material performance data 130 that uses a material as a resource, and method performance data 140 that uses a method as a resource.

### (Man Performance Data)

FIG. 9 is a diagram illustrating an example of contents of performance data for each type.

The man performance data 110 has a 4M type field 111, an occurrence time field 112, a manufacturing ID field 113, a business name field 114, a resource name field 115, a person-in-charge name field 116, and an event field 117.

The 4M type field 111 stores information indicating a type of a resource to be used to perform business (generate performance data). In the embodiment, the information indicates which element among 4M of production the performance data belongs to. With this 4M type information, the performance data can be allocated to the corresponding performance data table.

The occurrence time field 112 stores information indicating time when performance (or performance data) has occurred.

In the manufacturing ID field 113, a manufacturing ID is stored as information indicating a material (product) manufactured by performing business. With this manufacturing ID, various types of performance data of Man/Machine/Material/Method can be cross-related.

In the business name field 114, a name of business is stored as information indicating which business the performance (or performance data) for the manufacturing ID has occurred in.

The resource name field 115 stores a name of a resource as information indicating the resource.

In the person-in-charge name field 116, a name of a person in charge of work engaged in business (processing work in FIG. 9) is stored as information indicating details of a resource.

In the event field 117, information on an event (a start, an end, or the like) is stored as information indicating performance.

When there is no business name field in the performance data 100, the business name can be obtained by the following procedure. (1) A storage destination master table (herein, the man master table 320) is determined from the master table of FIG. 6 based on a 4M type and is searched with a resource name in the resource name field 115 to obtain a business ID. (2) The business master table 310 is searched with the business ID obtained in (1) to identify a business name. Alternatively, it is also conceivable a method of interpreting the resource name “person in charge of processing” to identify that business is “processing”. Since it is possible to directly or indirectly identify the business based on information on the resource, the performance data 100 does not necessarily include information indicating business in some cases.

### (Machine Performance Data)

The machine performance data 120 has a 4M type field 121, an occurrence time field 122, a manufacturing ID field 123, a business name field 124, a resource name field 125, a machine name field 126, and an event field 127.

The 4M type field 121, the occurrence time field 122, the manufacturing ID field 123, the business name field 124, the resource name field 125, and the event field 127 respectively correspond to the 4M type field 111, the occurrence time field 112, the manufacturing ID field 113, the business name field 114, the resource name field 115, and the event field 117 of the man performance data 110. The machine name field 126 stores a name of machine used for business as information indicating details of a resource.

### (Material Performance Data)

The material performance data 130 has a 4M type field 131, an occurrence time field 132, a manufacturing ID field 133, a business name field 134, a resource name field 135, a member name field 136, and a quantity field 137.

In the member name field 136, a name of a member or a material used or produced in business is stored as information indicating details of a resource.

In the quantity field 137, information indicating an increase or a decrease from a set value (an initial number, a target number, or the like) of a quantity of target members is stored as information indicating performance. This information may be a value of the quantity of target members.

### (Method Performance Data)

The method performance data 140 has a 4M type field 141, an occurrence time field 142, a manufacturing ID field 143, a business name field 144, a resource name field 145, a procedure name field 146, and a result field 147.

In the procedure name field 146, a name of a method (procedure) used in business is stored as information indicating details of a resource.

In the result field 147, information (OK, NG, or the like) on a result of executing the method instructed in the business is stored as information indicating performance.

The information stored in the event fields 117 and 127, the quantity field 137, and the result field 147 in the performance data 110 to 140 is information (contents) indicating the performance data itself, and can be said to be actual data handled by the business application 901 as performance.

### [Performance Data Table Accumulating Performance Data]

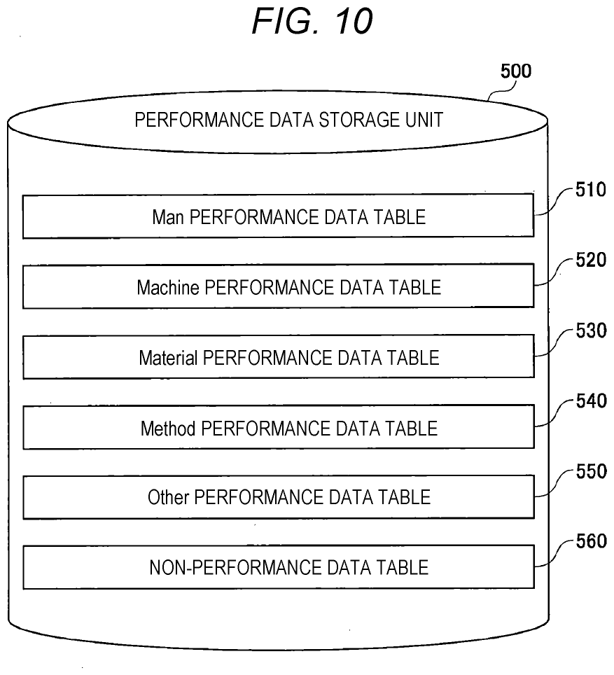

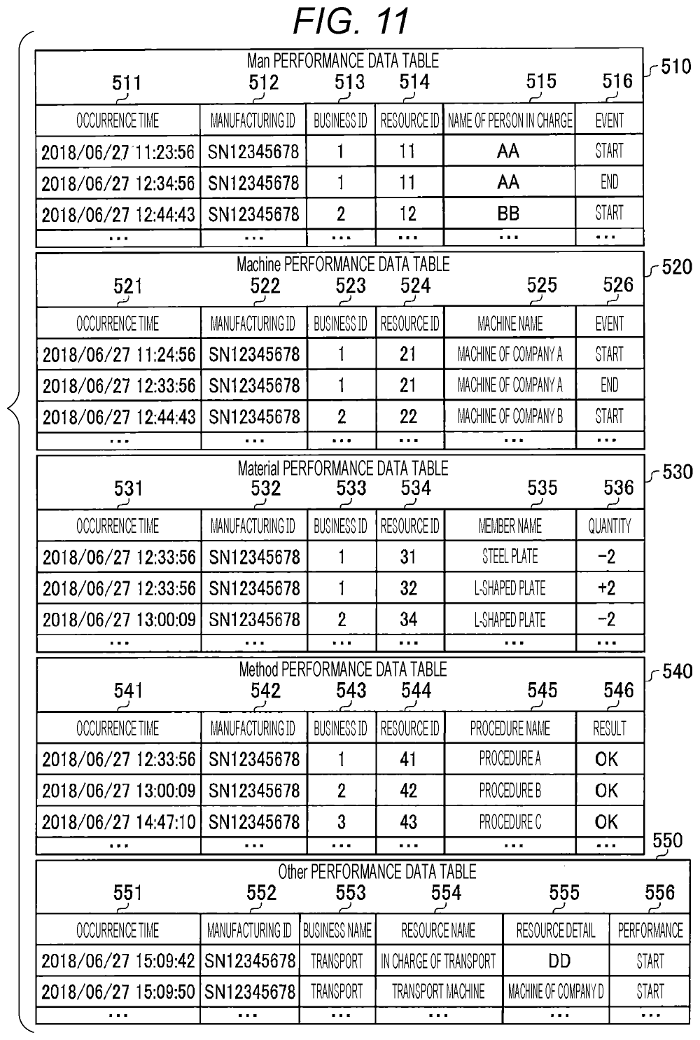

Next, the performance data table stored in the performance data storage unit 500 will be described with reference to FIGS. 10 and 11. The performance data collection processing unit 400 classifies the performance data 100 for each resource type based on the business context (see FIG. 6) and stores the classified performance data 100 in the performance data storage unit 500.

FIG. 10 is a diagram illustrating a configuration example of the performance data storage unit 500.

The performance data storage unit 500 stores a man performance data table 510, a machine performance data table 520, a material performance data table 530, a method performance data table 540, another performance data table 550, and a non-performance data table 560.

The man performance data table 510 stores the man performance data 110.

The machine performance data table 520 stores the machine performance data 120.

The material performance data table 530 stores the material performance data 130.

The method performance data table 540 stores the method performance data 140.

The other performance data table 550 stores performance data that is not stored in any of the 4M performance data tables 510 to 540.

The non-performance data table 560 stores performance data that is hardly classified into 4M out of the performance data stored in the other performance data table 550.

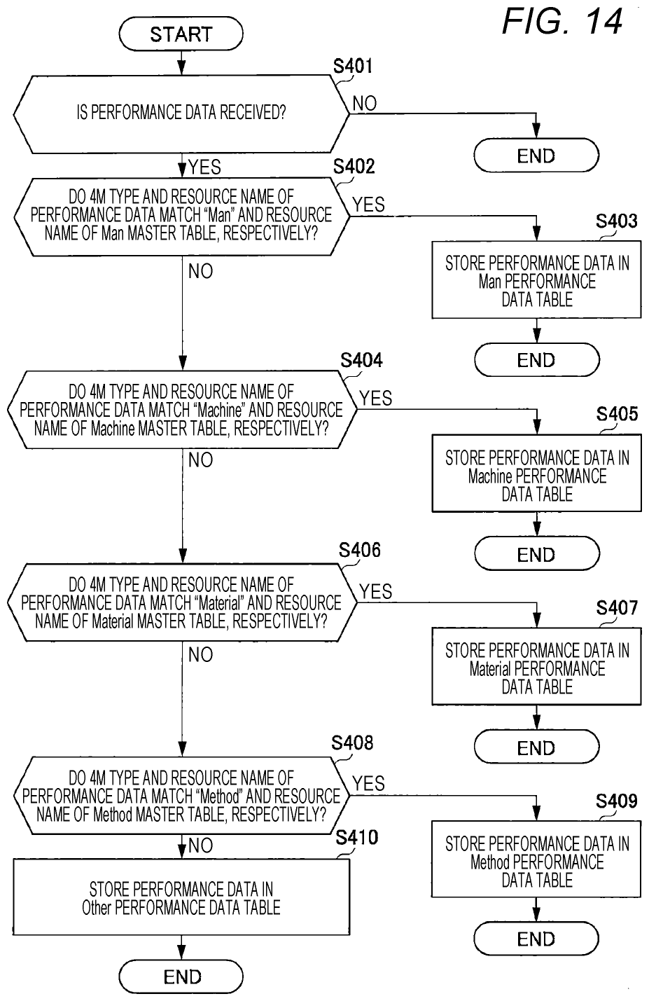

The storage of performance data in each of the 4M performance data tables 510 to 540 and the other performance data table 550 will be described later with reference to FIG. 14.

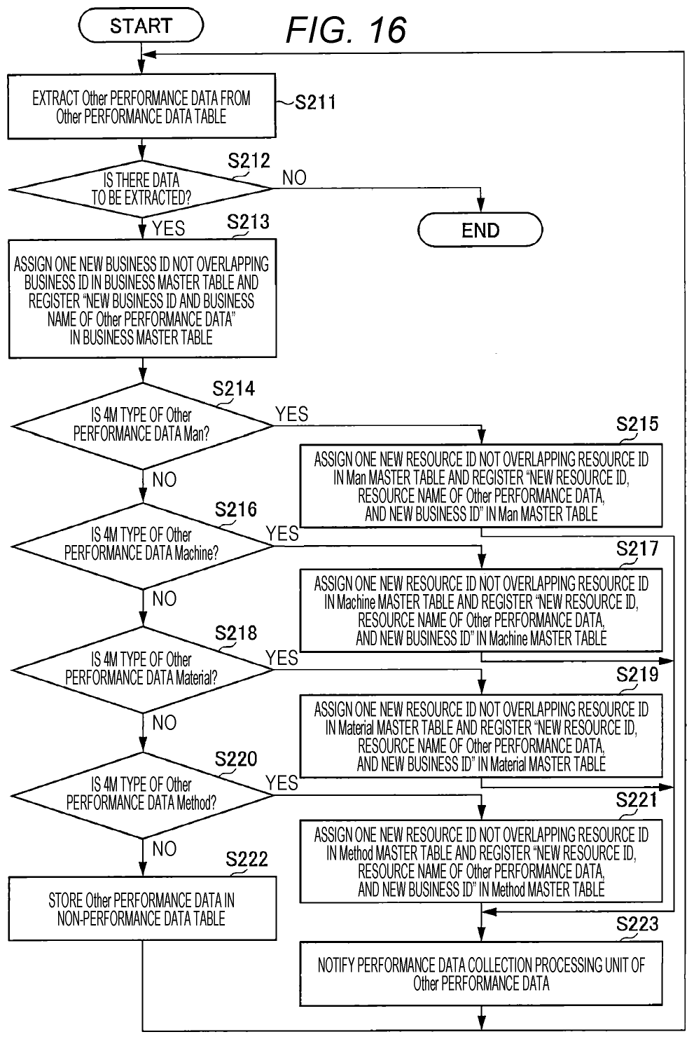

Further, the storage of performance data in the non-performance data table 560 will be described later with reference to FIG. 16.

### (Man Performance Data Table)

FIG. 11 is a diagram illustrating a configuration example of each performance data table stored in the performance data storage unit 500.

The man performance data table 510 has an occurrence time field 511, a manufacturing ID field 512, a business ID field 513, a resource ID field 514, a person-in-charge name field 515, and an event field 516.

The occurrence time field 511 corresponds to the occurrence time field 112 of the man performance data 110. The manufacturing ID field 512 corresponds to the manufacturing ID field 113 of the man performance data 110.

The business ID field 513 stores a business ID corresponding to the business name illustrated in the business name field 114 of the man performance data 110. The business ID corresponding to the business name is obtained from the business master table 310 (see FIG. 6).

The resource ID field 514 stores a resource ID corresponding to the resource name illustrated in the resource name field 115 of the man performance data 110. The resource ID corresponding to the resource name is obtained by referring to the man master table 320 (see FIG. 6).

The person-in-charge name field 515 corresponds to the person-in-charge name field 116 of the man performance data 110. The event field 516 corresponds to the event field 117 of the man performance data 110.

### (Machine Performance Data Table)

The machine performance data table 520 has an occurrence time field 521, a manufacturing ID field 522, a business ID field 523, a resource ID field 524, a machine name field 525, and an event field 526.

The occurrence time field 521 corresponds to the occurrence time field 122 of the machine performance data 120 (see FIG. 9). The manufacturing ID field 522 corresponds to the manufacturing ID field 123 of the machine performance data 120.

The business ID field 523 stores a business ID corresponding to the business name illustrated in the business name field 124 of the machine performance data 120.

The resource ID field 524 stores a resource ID corresponding to the resource name illustrated in the resource name field 125 of the machine performance data 120. The resource ID corresponding to the resource name is obtained by referring to the machine master table 330 (see FIG. 6).

The machine name field 525 corresponds to the machine name field 126 of the machine performance data 120. The event field 526 corresponds to the event field 127 of the machine performance data 120.

### (Material Performance Data Table)

The material performance data table 530 has an occurrence time field 531, a manufacturing ID field 532, a business ID field 533, a resource ID field 534, a member name field 535, and a quantity field 536.

The occurrence time field 531 corresponds to the occurrence time field 132 of the material performance data 130 (see FIG. 9). The manufacturing ID field 532 corresponds to the manufacturing ID field 133 of the material performance data 130.

The business ID field 533 stores a business ID corresponding to the business name illustrated in the business name field 134 of the material performance data 130.

The resource ID field 534 stores a resource ID corresponding to the resource name illustrated in the resource name field 135 of the material performance data 130. The resource ID corresponding to the resource name is obtained by referring to the material master table 340 (see FIG. 6).

The member name field 535 corresponds to the member name field 136 of the material performance data 130. The quantity field 536 corresponds to the quantity field 137 of the material performance data 130.

### (Method Performance Data Table)

The method performance data table 540 has an occurrence time field 541, a manufacturing ID field 542, a business ID field 543, a resource ID field 544, a procedure name field 545, and a result field 546.

The occurrence time field 541 corresponds to the occurrence time field 142 of the method performance data 140 (see FIG. 9). The manufacturing ID field 542 corresponds to the manufacturing ID field 143 of the method performance data 140.

The business ID field 543 stores a business ID corresponding to the business name illustrated in the business name field 144 of the method performance data 140.

The resource ID field 544 stores a resource ID corresponding to the resource name illustrated in the resource name field 145 of the method performance data 140. The resource ID corresponding to the resource name can be obtained by referring to the method master table 350 (see FIG. 6).

The procedure name field 545 corresponds to the procedure name field 146 of the method performance data 140. The result field 546 corresponds to the result field 147 of the method performance data 140.

### (Other Performance Data Table)

The other performance data table 550 has an occurrence time field 551, a manufacturing ID field 552, a business name field 553, a resource name field 554, a resource detail field 555, and a performance field 556.

The occurrence time field 551 corresponds to the occurrence time fields of the respective pieces of 4M performance data 110 to 140 (see FIG. 9).

The manufacturing ID field 552 corresponds to the manufacturing ID fields of the respective pieces of 4M performance data 110 to 140.

The business name field 553 stores a business name included in the performance data 100 output from the manufacturing site system 1. A business name “transport” in FIG. 11 is not registered in the business master table 310 (see FIG. 6).

The resource name field 554 stores a resource name included in the performance data 100 output from the manufacturing site system 1. Resource names “person in charge of transport” and “transport machine” in FIG. 11 are not registered in any of the master tables 320 to 350 in FIG. 6.

The resource detail field 555 stores information indicating details of a resource such as a name of a person in charge, a machine name, a member name, and a procedure name.

The performance field 556 stores information (a character string, a number, or the like) indicating performance such as an event, a quantity, and a result.

Here, start time and end time for the same manufacturing ID “SN12345678” differ between the man performance data table 510 and the machine performance data table 520. The processing start time by a person AA in charge of work is one minute earlier than the processing start time by machine of a company A, and conversely, the processing end time by the person AA in charge of work is one minute later than the processing end time by the machine of the company A. Such an event occurs in a case where, for example, the person AA in charge of work inputs worker information and a report of the processing work start to the terminal device 31 or the machine of the company A, and then, performs a processing start operation on the machine of the company A. Conversely, the event occurs in a case where the person AA in charge of work inputs the worker information and a report of the processing work end to the terminal device 31 or the machine of the company A after performing a processing end operation on the machine of the company A, and then, performs a processing start operation on the machine of the company A.

For example, if a work content of the person in charge of work at the time of processing is monitoring of a processing machine or confirmation of a processed product, a work time of the person in charge of work is sometimes shorter than an operation time of the processing machine. Further, the performance occurrence time by a man is sometimes the same as the performance occurrence time by machine depending on a condition. In this manner, each performance occurrence time of Man/Machine/Material/Method differs depending on a content and a procedure of business.

### [Business Data Table]

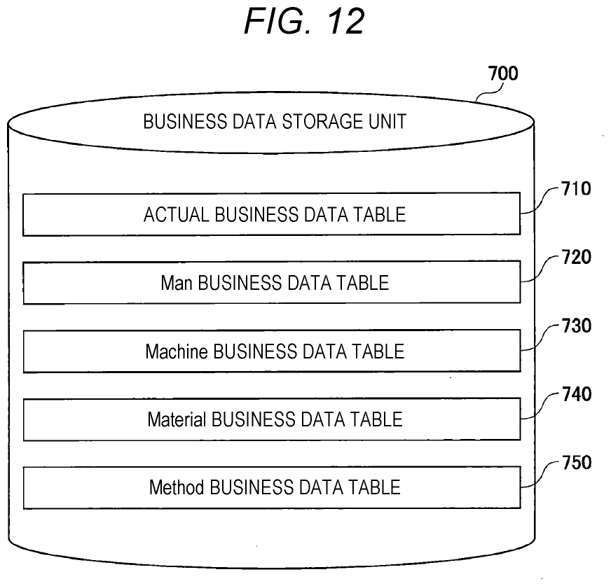

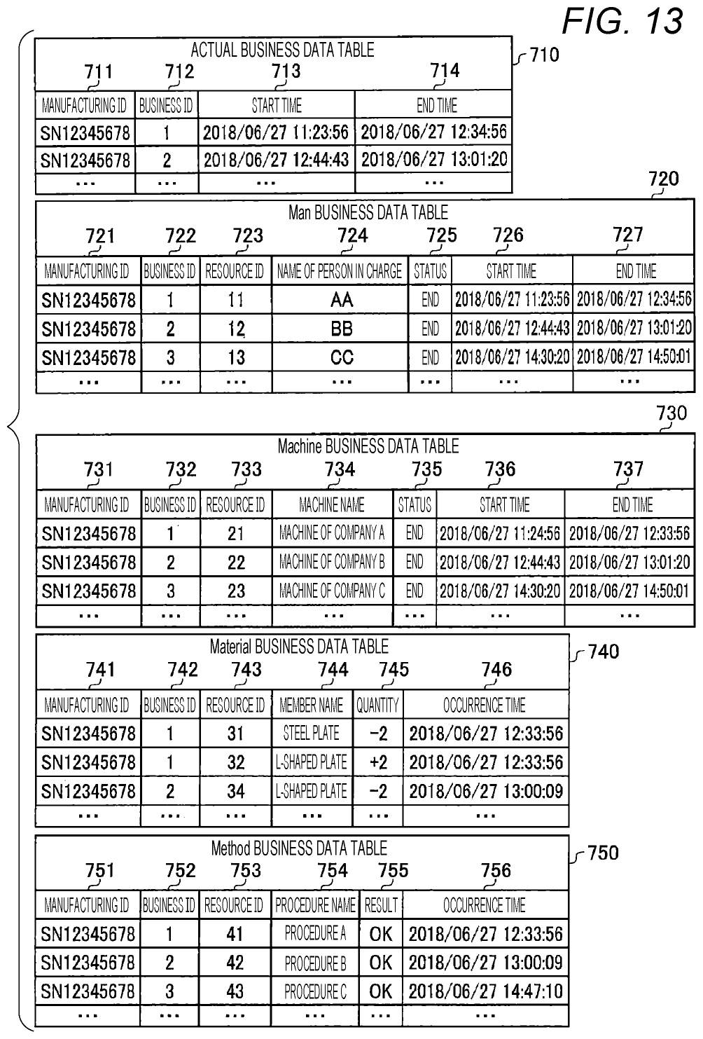

Next, a business data table stored in the business data storage unit 700 will be described with reference to FIGS. 12 and 13. The business data generation processing unit 600 associates business with performance data classified for each resource type to generate business data based on the business context (see FIG. 6), and stores the generated business data in the business data storage unit 700.

FIG. 12 is a diagram illustrating a configuration example of the business data storage unit 700.

The business data storage unit 700 stores an actual business data table 710, a man business data table 720, a machine business data table 730, a material business data table 740, and a method business data table 750.

### (Actual Business Data Table)

FIG. 13 is a diagram illustrating a configuration example of each business data table stored in the business data storage unit 700.

The actual business data table 710 has a manufacturing ID field 711, a business ID field 712, a start time field 713, and an end time field 714. The actual business data table 710 is obtained by collecting the performance data stored in the performance data storage unit 500 for each combination in which “manufacturing ID” and “business ID” are the same.

The manufacturing ID field 711 corresponds to the manufacturing ID field of each performance data table.

The business ID field 712 corresponds to the business ID field of each performance data table.

In the start time field 713, occurrence time in an occurrence time field of a record in which “start” is input in an event field is stored for each business ID.

In the end time field 714, occurrence time in an occurrence time field of a record in which “end” is input in an event field is stored for each business ID.

### (Man Business Data Table)

The man business data table 720 has a manufacturing ID field 721, a business ID field 722, a resource ID field 723, a person-in-charge name field 724, a status field 725, a start time field 726, and an end time field 727. In each of the business data tables 720 to 750, the performance data is collected with the same resource ID.

The manufacturing ID field 721 corresponds to the manufacturing ID field 512 of the man performance data table 510.

The business ID field 722 corresponds to the business ID field 513 of the man performance data table 510.

The resource ID field 723 corresponds to the resource ID field 514 of the man performance data table 510.

The person-in-charge name field 724 corresponds to the person-in-charge name field 515 of the man performance data table 510.

The status field 725 stores information indicating a current status of a person in charge of work (one of resources) corresponding to a name of the person-in-charge indicated in the person-in-charge name field 724. In FIG. 13, since processing work of the person AA in charge of work has been ended, “end” is indicated in the status field 725.

In the start time field 726, the occurrence time of the occurrence time field 511 of the record in which “start” is input in the event field 516 is stored for each business ID of the man performance data table 510.

In the end time field 727, the occurrence time of the occurrence time field 511 of the record in which “end” is input in the event field 516 is stored for each business ID of the man performance data table 510.

### (Machine Business Data Table)

The machine business data table 730 has a manufacturing ID field 731, a business ID field 732, a resource ID field 733, a machine name field 734, a status field 735, a start time field 736, and an end time field 737.

The manufacturing ID field 731 corresponds to the manufacturing ID field 522 of the machine performance data table 520.

The business ID field 732 corresponds to the business ID field 523 of the machine performance data table 520.

The resource ID field 733 corresponds to the resource ID field 524 of the machine performance data table 520.

The machine name field 734 corresponds to the machine name field 525 of the machine performance data table 520.

The status field 735 stores information indicating a current status of machine (resource) corresponding to the machine name indicated in the machine name field 734. In FIG. 13, since the processing of the machine of the company A has been completed, “end” is indicated in the status field 735.

In the start time field 736, the occurrence time of the occurrence time field 521 of the record in which “start” is input in the event field 526 is stored for each business ID of the machine performance data table 520.

In the end time field 737, the occurrence time of the occurrence time field 521 of the record in which “end” is input in the event field 526 is stored for each business ID of the machine performance data table 520.

### (Material Business Data Table)

The material business data table 740 has a manufacturing ID field 741, a business ID field 742, a resource ID field 743, a member name field 744, a quantity field 745, and an occurrence time field 746.

The manufacturing ID field 741 corresponds to the manufacturing ID field 532 of the material performance data table 530.

The business ID field 742 corresponds to the business ID field 533 of the material performance data table 530.

The resource ID field 743 corresponds to the resource ID field 534 of the material performance data table 530.

The member name field 744 corresponds to the member name field 535 of the material performance data table 530.

The quantity field 745 corresponds to the quantity field 536 of the material performance data table 530.

The occurrence time field 746 corresponds to the occurrence time field 531 of the material performance data table 530.

### (Method Business Data Table)

The method business data table 750 includes a manufacturing ID field 751, a business ID field 752, a resource ID field 753, a procedure name field 754, a result field 755, and an occurrence time field 756.

The manufacturing ID field 751 corresponds to the manufacturing ID field 542 of the method performance data table 540.

The business ID field 752 corresponds to the business ID field 543 of the method performance data table 540.

The resource ID field 753 corresponds to the resource ID field 544 of the method performance data table 540.

The procedure name field 754 corresponds to the procedure name field 545 of the method performance data table 540.

The result field 755 corresponds to the result field 546 of the method performance data table 540.

The occurrence time field 756 corresponds to the occurrence time field 541 of the method performance data table 540.

### [Procedure of Performance Data Collection Processing]

Next, an example of a processing procedure of the performance data collection processing unit 400 will be described with reference to FIG. 14.

FIG. 14 is a flowchart illustrating the example of the processing procedure of the performance data collection processing unit 400.

First, the performance data collection processing unit 400 (see FIG. 2) determines whether the performance data 100 has been received from the manufacturing site system 1 (S401), and ends the processing of this flowchart when the performance data 100 has not been received (No in S401).

Next, when the performance data 100 has been received (Yes in S401), the performance data collection processing unit 400 determines whether a 4M type of the performance data 100 is “man” and a resource name matches a resource name in the man master table 320 (see FIG. 6) (S402). When the performance data 100 satisfies a condition of this logical product (Yes in S402), the performance data collection processing unit 400 stores the performance data 100 in the man performance data table 510 (see FIG. 11) (S403), and ends the processing of this flowchart.

Next, when the 4M type of the performance data 100 is not “man” or the resource name does not match the resource name of the man master table 320 (No in S402), the performance data collection processing unit 400 determines whether the 4M type of the performance data 100 is “machine” and the resource name matches a resource name in the machine master table 330 (see FIG. 6) (S404). When the performance data 100 satisfies a condition of this logical product (Yes in S404), the performance data collection processing unit 400 stores the performance data 100 in the machine performance data table 520 (see FIG. 11) (S405), and ends the processing of this flowchart.

Next, when the 4M type of the performance data 100 is not “machine” or the resource name does not match the resource name of the machine master table 330 (No in S404), the performance data collection processing unit 400 determines whether the 4M type of the performance data 100 is “material” and the resource name matches a resource name in the material master table 340 (see FIG. 6) (S406). When the performance data 100 satisfies a condition of this logical product (Yes in S406), the performance data collection processing unit 400 stores the performance data 100 in the material performance data table 530 (see FIG. 11) (S407), and ends the processing of this flowchart.

Next, when the 4M type of the performance data 100 is not “material” or the resource name does not match the resource name in the material master table 340 (No in S406), the performance data collection processing unit 400 determines whether the 4M type of the performance data 100 is “method” and the resource name matches the resource name in the method master table 350 (see FIG. 6) (S408). When the performance data 100 satisfies a condition of this logical product (Yes in S408), the performance data collection processing unit 400 stores the performance data 100 in the method performance data table 540 (see FIG. 11) (S409), and ends the processing of this flowchart.

Next, when the 4M type of the performance data 100 is not “method” or the resource name does not match the resource name in the method master table 350 (No in S408), the performance data collection processing unit 400 stores the performance data 100 in the other performance data table 550 (see FIG. 11) (S410). After the process of step S410, the processing of this flowchart is ended.

Through such performance data collection processing, the performance data output from the manufacturing site system 1 is classified into 4M which are the four elements of production.

### [Procedure of Business Data Generation Processing]

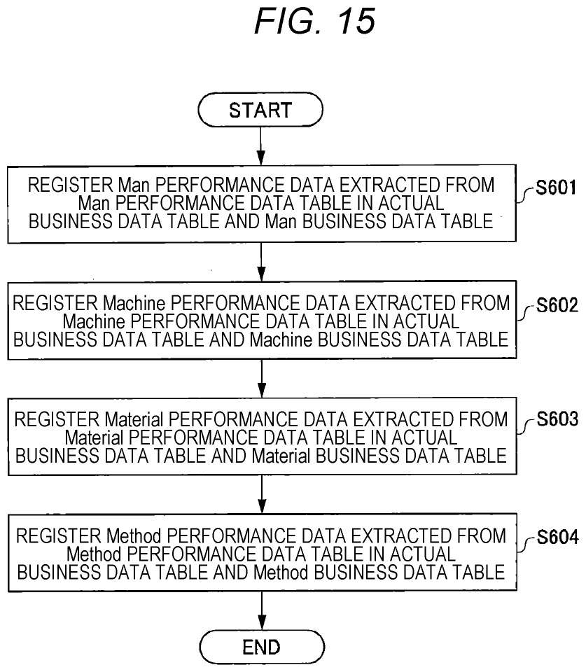

Next, an example of a processing procedure of the business data generation processing unit 600 will be described with reference to FIG. 15.

FIG. 15 is a flowchart illustrating the example of the processing procedure of the business data generation processing unit 600.

First, the business data generation processing unit 600 registers information on performance data (man performance data) extracted from the man performance data table 510 in the actual business data table 710 and the man business data table 720 illustrated in FIG. 13 (S601).

Next, the business data generation processing unit 600 registers information on performance data (machine performance data) extracted from the machine performance data table 520 in the actual business data table 710 and the machine business data table 730 illustrated in FIG. 13 (S602).

Next, the business data generation processing unit 600 registers information on performance data (material performance data) extracted from the material performance data table 530 in the actual business data table 710 and the material business data table 740 illustrated in FIG. 13 (S603).

Next, the business data generation processing unit 600 registers information on performance data (method performance data) extracted from the method performance data table 540 in the actual business data table 710 and the method business data table 750 illustrated in FIG. 13 (S604). After the process of step S604, the processing of this flowchart is ended.

Through such business data generation processing, business and performance data relating to the business are classified into 4M which are the four elements of production and managed.

### [Procedure of Business Context Automatic Registration Processing]

Next, an example of a processing procedure of the business context automatic registration processing unit 210 will be described with reference to FIG. 16.

FIG. 16 is a flowchart illustrating the example of the processing procedure of the business context automatic registration processing unit 210.

First, the business context automatic registration processing unit 210 performs processing of extracting (reading) performance data (also referred to as “other performance data”) from the other performance data table 550 illustrated in FIG. 11 (S211). Here, the business context automatic registration processing unit 210 determines whether there is other performance data (record) to be extracted in the other performance data table 550 (S212), and ends the processing of this flowchart when there is no other performance data to be extracted (No in S212).

Next, when there is other performance data to be extracted in the other performance data table 550 (Yes in S212), the business context automatic registration processing unit 210 assigns one new business ID, which does not overlap a business ID in the business master table 310 of FIG. 3, to the other performance data. Then, the business context automatic registration processing unit 210 registers “new business ID” and “business name of other performance data” in the business master table 310.

Next, the business context automatic registration processing unit 210 determines whether a 4M type of the other performance data extracted from the other performance data table 550 is “man” (S214). When the 4M type of the other performance data is “man” (Yes in S214), the business context automatic registration processing unit 210 assigns one new resource ID, which does not overlap a resource ID in the man master table 320, to the other performance data. Then, “new resource ID”, “resource name of other performance data”, and “new business ID” are registered in the man master table 320 (S215). After the process of step S215, the processing proceeds to step S223.

Next, when the 4M type of the other performance data is not “man” (No in S214), the business context automatic registration processing unit 210 determines whether the 4M type of the other performance data extracted from the other performance data table 550 is “machine” (S216). When the 4M type of the other performance data is “machine” (Yes in S216), the business context automatic registration processing unit 210 assigns one new resource ID, which does not overlap a resource ID in the machine master table 330, to the other performance data. Then, “new resource ID”, “resource name of other performance data”, and “new business ID” are registered in the machine master table 330 (S217). After the process of step S217, the processing proceeds to step S223.

Next, when the 4M type of the other performance data is not “machine” (No in S216), the business context automatic registration processing unit 210 determines whether the 4M type of the other performance data extracted from the other performance data table 550 is “material” (S218). When the 4M type of the other performance data is “material” (Yes in S218), the business context automatic registration processing unit 210 assigns one new resource ID, which does not overlap a resource ID in the material master table 340, to the other performance data. Then, “new resource ID”, “resource name of other performance data”, and “new business ID” are registered in the material master table 340 (S219). After the process of step S219, the processing proceeds to step S223.

Next, when the 4M type of the other performance data is not “material” (No in S218), the business context automatic registration processing unit 210 determines whether the 4M type of the other performance data extracted from the other performance data table 550 is “method” (S220). When the 4M type of the other performance data is “method” (Yes in S220), the business context automatic registration processing unit 210 assigns one new resource ID, which does not overlap the resource ID in the method master table 350, to the other performance data. Then, “new resource ID”, “resource name of other performance data”, and “new business ID” are registered in the method master table 350 (S221). After the process of step S221, the processing proceeds to step S223.

Then, after the process of step S215, 5217, 5219, or S221, the business context automatic registration processing unit 210 notifies the performance data collection processing unit 400 of the target other performance data (S223), and the processing proceeds to step S211. The performance data collection processing unit 400 notified of the other performance data executes the performance data collection processing of FIG. 14, and stores the notified other performance data in the corresponding performance data table according to a type of 4M based on the business context to which the new business context has been added.

On the other hand, when the 4M type of the other performance data is not “method” (No in S220), the business context automatic registration processing unit 210 stores the other performance data in the non-performance data table 560 (see FIG. 10) (S222). After the process of step S222, the processing proceeds to step S211.

Through such business context automatic registration processing, when the performance data management device 200 receives new type of performance data, it is possible to classify and manage the new type of performance data without intervention of human and to provide the business application 901 with the new type of performance data (business data).

According to the embodiment configured as described above, a large number of pieces of performance data and business generated by the control system at the manufacturing site are managed for each resource type (for each category of performance data). As a result, a reference source of the performance data can refer only to required performance data easily from among a large number of pieces of performance data.

Further, business and performance data relating to the business are managed in the state of being classified into 4M, which are the four elements of production, in the embodiment, and thus, a person in charge of a business application can refer only to required performance data. As a result, it is possible to reduce a burden on the person in charge of the business application. In the embodiment, there is no impact on existing business application that does not need to refer to new performance data when creating a new business application that requires the new performance data.

Further, when the business application is applied to another manufacturing site in the invention, it becomes easy to limit a range of influence only between the provision of performance data from the manufacturing site system and the performance data management device receiving the performance data. Here, since a format of the performance data provided from the manufacturing site system to the performance data management device has been defined, a burden on a person in charge of the control system is reduced as compared to the conventional system.

### [Performance Data Stored in Business Data Storage Unit]

Next, an example of performance data stored in the business data storage unit 900 will be described. Here, an example of the first business data storage unit 900-1 will be described as a representative of the business data storage unit 900.

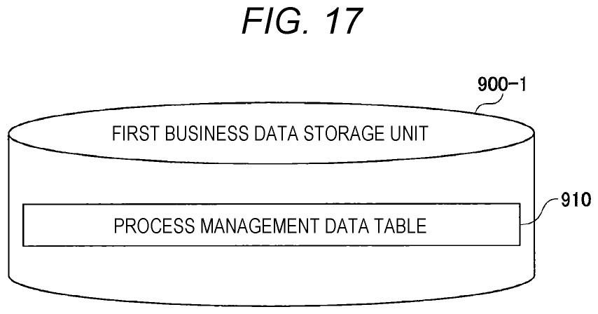

FIG. 17 is a diagram illustrating a configuration example of the first business data storage unit 900-1.

The first business data storage unit 900-1 stores a process management data table 910 that is accessed by the first business application 901-1. The process management is an example, and the purpose of the business application is not limited thereto.

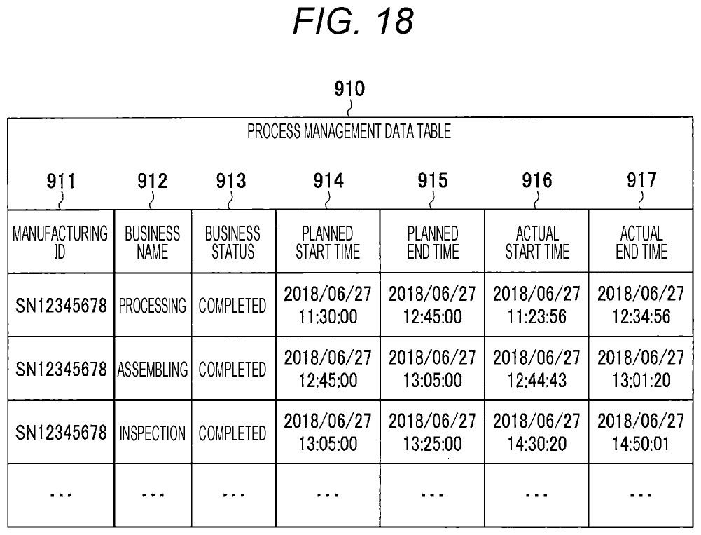

FIG. 18 is a diagram illustrating a configuration example of the process management data table 910.

The process management data table 910 is created by the first business ETL 800-1. The process management data table 910 has a manufacturing ID field 911, a business name field 912, a business status field 913, a planned start time field 914, a planned end time field 915, an actual start time field 916, and an actual end time field 917.

The manufacturing ID field 911 corresponds to the manufacturing ID field 711 of the actual business data table 710 illustrated in FIG. 13.

The business name field 912 stores a business name corresponding to the business ID illustrated in the business ID field 712 of the actual business data table 710. The business name corresponding to the business ID is obtained by referring to the business master table 310 (see FIG. 6). Since the business name is used instead of the business ID illustrated in the actual business data table 710, the person in charge of work who uses the business application can easily understand contents of business.

The business status field 913 stores information on a status of the business identified using the business name indicated in the business name field 912. When creating or updating the process management data table 910, the first business ETL 800-1 determines the business status based on the information in the business data tables 720 to 750 of the respective resources. For example, the first business ETL 800-1 determines the business status as “completed” when each information in the status field 725 of the man business data table 720 and the status field 735 of the machine business data table is “end” and when information is registered in the quantity field 745 of the material business data table 740 and the result field 755 of the method business data table 750.

The planned start time field 914 stores information on start time of target business at a planning stage.

The planned end time field 915 stores information on end time of the target business at the planning stage.

The actual start time field 916 stores actual start time of the target business. In FIG. 18, the time indicated in the actual start time field 916 is the same as the time indicated in the start time field 726 of the man business data table 720.

The actual end time field 917 stores actual end time of the target business. In FIG. 18, the time indicated in the actual end time field 917 is the same as the time indicated in the end time field 727 of the man business data table 720.

The process management data table 910 stored in the first business data storage unit 900-1 has no information on resource details such as a name of a person in charge or a machine name included in the performance data. This is because the first business ETL 800-1 has extracted only the performance data, required for the process management by the first business application 901-1, from the business data storage unit 700. Since only the required performance data among pieces of performance data is provided to the business application in the business ETL 800, the business application 901 and the person in charge of the business application can refer only to the required performance data.

### [Processing Procedure of Business ETL]

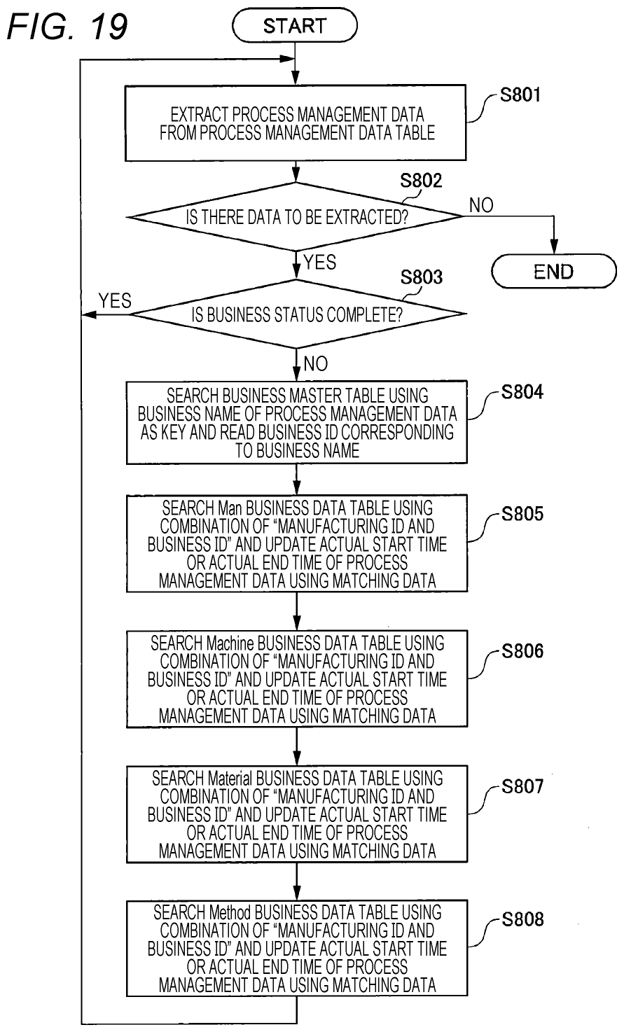

Next, an example of a processing procedure of the first business ETL 800-1 will be described with reference to FIG. 19.

FIG. 19 is a flowchart illustrating the example of the processing procedure of the first business ETL 800-1.

First, the first business ETL 800-1 performs processing of extracting (reading) process management data from the process management data table 910 illustrated in FIG. 18 (S801). Here, the first business ETL 800-1 determines whether there is the process management data (record) to be extracted in the process management data table 910 (S802), and ends the processing of this flowchart when there is no process management data to be extracted (No in S802).

Next, when there is the process management data to be extracted in the process management data table 910 (Yes in S802), the first business ETL 800-1 determines whether a business status in the business status field 913 of the extracted process management data is “completed” (S803). When the business status in the business status field 913 is “completed” (Yes in S803), the first business ETL 800-1 returns to step S801 to perform the processing of extracting process management data of the next record, and performs processes in steps S802 to S808 as appropriate.

Next, when the business status in the business status field 913 is not “completed” (No in S803), the first business ETL 800-1 searches the business master table 310 (see FIG. 6) using a business name of the process management data as a key, and reads a business ID corresponding to the business name (S804).

Next, the first business ETL 800-1 searches the man business data table 720 with a combination of “manufacturing ID and business ID”, and updates the actual start time and/or actual end time of the process management data using the matching performance data (S805).

Next, the first business ETL 800-1 searches the machine business data table 730 with the combination of “manufacturing ID and business ID”, and updates the actual start time and/or actual end time of the process management data using the matching performance data (S806).

Next, the first business ETL 800-1 searches the material business data table 740 with the combination of “manufacturing ID and business ID”, and updates the actual start time and/or actual end time of the process management data using the matching performance data (S807).

Next, the first business ETL 800-1 searches the method business data table 750 with the combination of “manufacturing ID and business ID”, and updates the actual start time and/or actual end time of the process management data using the matching performance data (S808).

Next, after the process in step S808, the first business ETL 800-1 returns to step S801 to perform the processing of extracting process management data of the next record, and performs processes in steps S802 to S808 as appropriate.

In the embodiment described above, work time of “man” is the longest among other resources as indicated in the man business data table 720 of FIG. 13. In this case, the start time and end time of the man business data table 720 are reflected to the start time and the actual end time of the process management data in step S805, and then, the start time and the actual end time of the process management data are not updated with data of other business data tables in steps S806 to S808.

### 2. Modification

Although the example in which performance data (resources) is classified into the four elements of production has been described in the above embodiment, the performance data (resources) may be classified into three elements or two elements among the four elements. Alternatively, the performance data (resources) may be classified into different types of elements from the four elements of production.

The invention is not limited to the above embodiment, and can be applied to all systems such as a factory automation (FA) system and a process automation (PA) system. In particular, the invention is suitable for an application to a system in which start time and end time of processes and work are obtained as performance data.

The invention is not limited to the above embodiment, and it is a matter of course that various other applications and modifications can be made without departing from a gist of the invention described in the claims.

For example, the above embodiment describes the detailed and concrete description of the configuration of the performance data management device in order to describe the invention in an easily understandable manner, and are not necessarily limited to one including all constituent elements that have been described above. Further, addition, deletion or substitution of other constituent elements can be also made with respect to some configurations of the embodiment.

Further, a part or all of each of the above-described configurations, functions, processing units, and the like of the above embodiment may be realized, for example, by hardware by designing with an integrated circuit and the like.

Further, each constituent element of the performance data management device according to the embodiment of the present disclosure described above may be mounted to any hardware as long as the respective pieces of hardware can transmit and receive information to and from each other via a network. Further, a process performed by a certain processor may be realized by a single piece of hardware, or may be realized by a distributed process using a plurality of pieces of hardware.

1. A performance data management device comprising:
a performance data collection processing unit that classifies performance data for each type of a resource based on business context indicating a relationship between business and the resource when the performance data generated by a manufacturing site system includes information indicating the type of the resource used to perform the business, time at which performance of the resource has occurred, information indicating a material to be manufactured by performing the business, information indicating the business, information indicating the resource, and information indicating the performance of the resource;
a performance data storage unit that stores the performance data classified for each type of the resource;
a business data generation processing unit that associates the business with the performance data classified for each type of the resource based on the business context and generates business data; and
a business data storage unit that stores the business data for each type of the resource.

2. The performance data management device according to claim 1, further comprising:
a business context storage unit that stores the business context; and
a business context automatic registration processing unit that generates new business context based on information added to the performance data when it is difficult to classify the performance data by the business context in the performance data collection processing unit, and automatically registers the new business context in the business context storage unit.

3. The performance data management device according to claim 1, further comprising
a business context definition execution unit that executes a definition of the business context based on an input instruction.

4. The performance data management device according to claim 1, wherein
types of the performance data include performance data that uses a man as the resource, performance data that uses machine as the resource, performance data that uses a material as the resource, and performance data that uses a method as the resource.

5. The performance data management device according to claim 4, wherein
the performance data storage unit stores a table in which the performance data using the man as the resource is registered, a table in which the performance data using the machine as the resource is registered, a table in which the performance data using the material as the resource is registered, and a table in which the performance data using the method as the resource is registered.

6. The performance data management device according to claim 2, wherein
the business context storage unit stores a master table indicating a correspondence between business identification information and a business name, a master table in which the business context having a man as the resource is registered, a master table in which the business context having machine as the resource is registered, a master table in which the business context having a material as the resource is registered, and a master table in which the business context having a method as the resource is registered.

7. The performance data management device according to claim 1, wherein
the business data storage unit stores an actual business data table indicating start time and end time of the business, a business data table in which the business data having a man as the resource is registered, a business data table in which the business data having machine as the resource is registered, a business data table in which the business data having a material as the resource is registered, and a business data table in which the business data having a method as the resource is registered.

8. A performance data management device comprising:
a performance data collection processing unit that classifies performance data for each type of a resource based on business context indicating a relationship between business and the resource when the performance data generated by a manufacturing site system includes information indicating the type of the resource used to perform the business, time at which performance of the resource has occurred, information indicating a material to be manufactured by performing the business, information indicating the resource, and information indicating the performance of the resource;
a performance data storage unit that stores the performance data classified for each type of the resource;
a business data generation processing unit that associates the business with the performance data classified for each type of the resource based on the business context and generates business data; and
a business data storage unit that stores the business data for each type of the resource.

9. The performance data management device according to claim 8, wherein
types of the performance data include performance data that uses a man as the resource, performance data that uses machine as the resource, performance data that uses a material as the resource, and performance data that uses a method as the resource.

10. The performance data management device according to claim 9, wherein
each of the performance data that uses the man as the resource, the performance data that uses the machine as the resource, the performance data that uses the material as the resource, and the performance data that uses the method as the resource includes the information indicating the type of the resource to be used to perform the business, the time at which the performance of the resource has occurred, the information indicating the material to be manufactured by performing the business, the information indicating the resource, and the information indicating the performance of the resource.
